(19) United States
(12) Patent Application Publication
(10) Pub. No.: US 2011/0173773 A1
(43) Pub. Date: Jul. 21, 2011

(54) SYSTEM FOR CLEANING BUILDINGS

(76) Inventors: Ibrahim Ghulam Murad Ali, Dubai (AE); Saeed Najafi, Ramsar (IR); Mehdi Farzpourmachiani, Rasht (IR); Ali Farzpourmachiani, Rasht (IR)

(21) Appl. No.: 12/994,375

(22) PCT Filed: May 26, 2009
(86) PCT No.: PCT/GB2009/001316

§ 371 Date: Apr. 4, 2011

(30) Foreign Application Priority Data
May 23, 2008 (GB) 0809472.4

(51) Int. Cl. A47L 9/02; B08B 13/00

(52) U.S. Cl. 15/415.1; 15/300.1

(57) ABSTRACT

A system for cleaning buildings is provided. In this system, the danger of falling from height is reduced to a minimum. All the stages of cleaning buildings can be managed, directed and controlled from long distance and from any place. Some winches, steel wire, some types of joints, some nozzles of liquid and gas, liquid and gas tanks, one computer, and connection systems controlled by office are used in this system. With the present invention, a system for cleaning the surface of a building is provided, the system comprising: a cleaning head set (7) for supplying cleaning materials to the surface of the building (1); and the system further comprising means for displacing the cleaning head set, the means being configured to allow the cleaning head set to follow a surface contour of the building surface.

Cleaning buildings with nano cleaner can be managed, directed and controlled in a control office by a computer through a system according to an embodiment of the invention.

The control office can be in any place and has no distance limitation with the building. Most systems of cleaning the buildings are operated manually by human operators using their hand. They are in boxes hanging in the sky that is most often very dangerous. In the present system, the cleaning zone is limited due to the manual system of cleaning so the cleaning process is highly time-consuming.

Furthermore, due to the risks of falling from height, the boxes in which operators should stand are limited in terms of weight resulting in the limitation of cleaning materials carried by operators.

This method and system seeks to reduce or at least ameliorate at least one of the problems associated with the prior art.

According to a first aspect of the present invention there is provided a system as claimed in claim 1.

According to a further aspect of the present invention there is provided a system for cleaning the surface of a building, the system comprising:
a cleaning head set for supplying cleaning materials to the surface of the building; and
the system further comprising means for displacing the cleaning head set, the means being configured to allow the cleaning head set to follow a surface contour of the building surface.

Preferably, the means for displacing the cleaning head set is configured to allow the cleaning head set to move in two mutually orthogonal directions.

Preferably, the cleaning head set is provided with nozzles, the nozzles being configured to move generally perpendicular to the surface plane of the building, such that the nozzles can be adapted to the surface contour of the building.

Preferably, the means for displacing the cleaning head set includes;
a substantially horizontal support axis for supporting the cleaning head set;
means for adjusting the vertical displacement of the support axis; and
means for allowing reciprocal displacement of the cleaning head along the support axis.

Preferably, the means for adjusting the vertical displacement of the support axis comprises a pulley and winch system.

Preferably, the means for adjusting the vertical displacement of the support axis comprises vertical lifting units attached to the support axis.

Preferably, the support axis is formed to follow a curved profile.

Preferably, the system further comprises a computer for controlling the means for displacing the cleaning head set.

Preferably, the computer controls the supply of cleaning materials to the cleaning head set.

Preferably, the computer is provided with a wireless connection for controlling the cleaning head set.

Eliminating such inconveniences, this method no longer requires the use of operators or suspended boxes enabling a single operator to control and manage the system from a control office.

Furthermore, since cleaning material is carried through pipes from tanks placed on a car, no limitation is faced and the whole process becomes less time-consuming.

In current methods, cleaning the projection and indented surfaces is limited as it is carried out manually. However, the present method, utilising heads which are capable of getting small and big, experiences no limitation.

Preferred embodiments of the present invention will now be described by way of example with reference to and as illustrated in the accompanying drawings, in which:

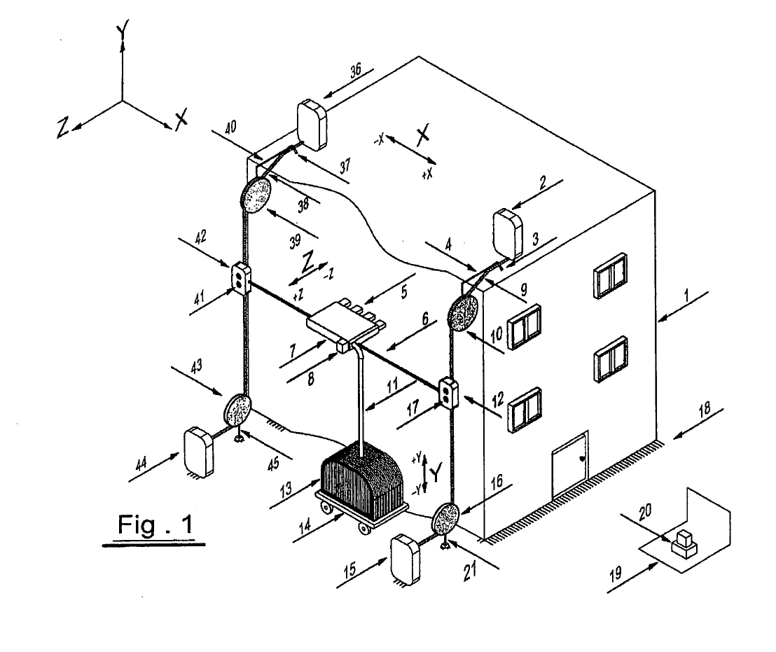

FIG. 1 is a schematic figure of a whole system;

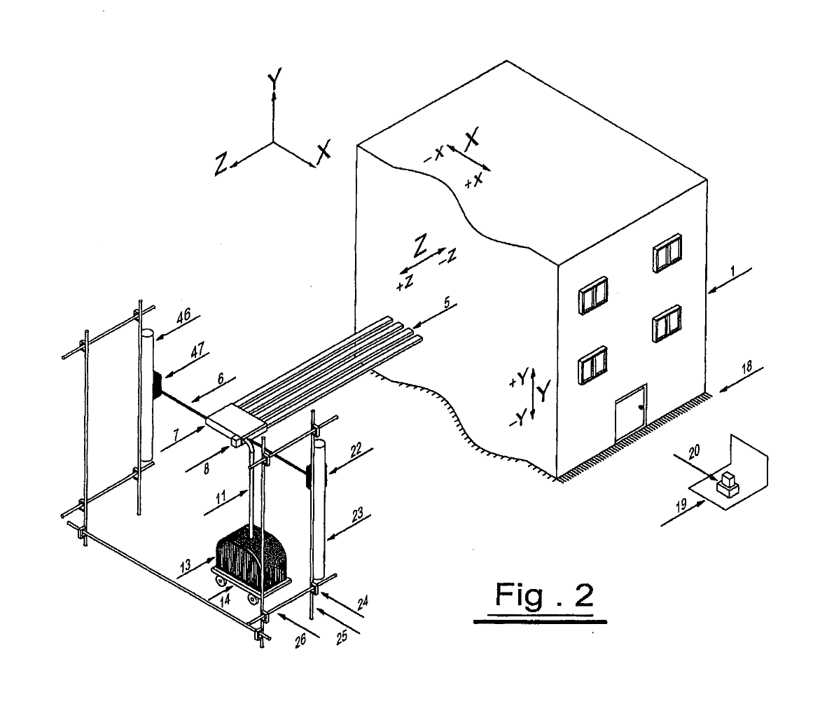

FIG. 2 is a schematic figure of a whole system when the system is not on a building;

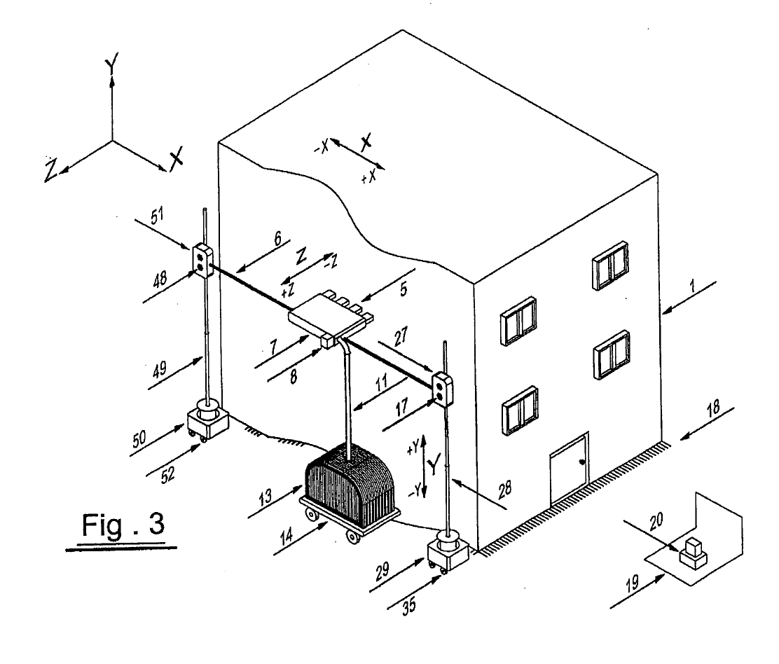

FIG. 3 is a schematic figure of a whole system when the system is placed on moving and portable lifters;

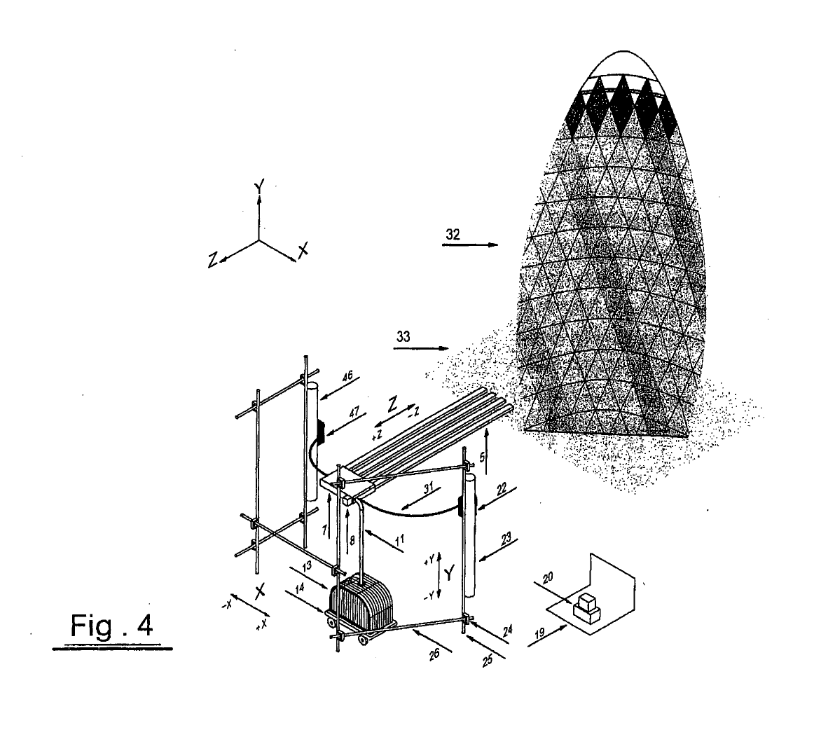

FIG. 4 is a schematic figure of a whole system when the system is used in a building with geometric and curved shapes;

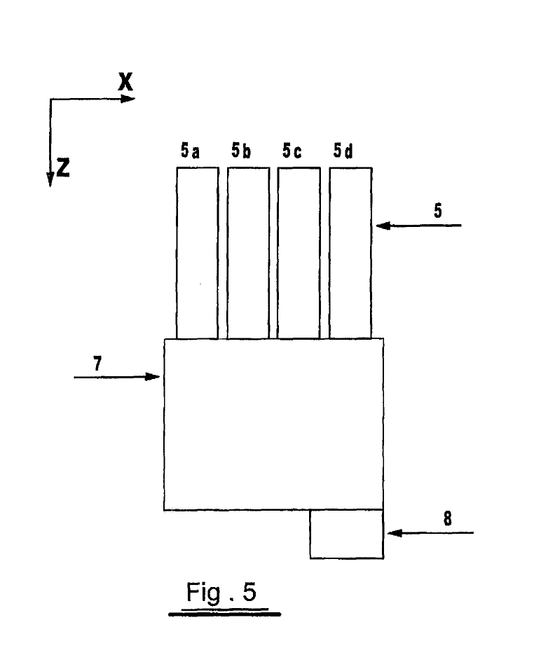

FIG. 5 is a figure of a cleaning head;

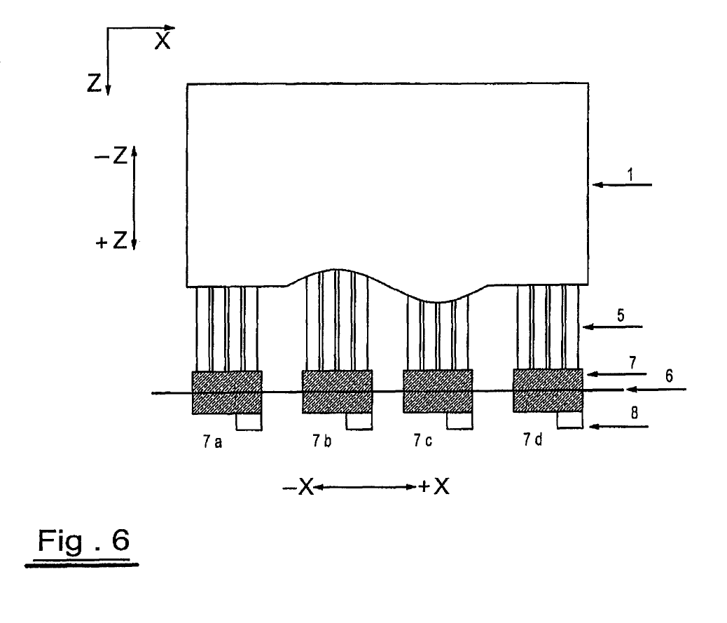

FIG. 6 shows different positions of a cleaning head in different stages of cleaning a building;

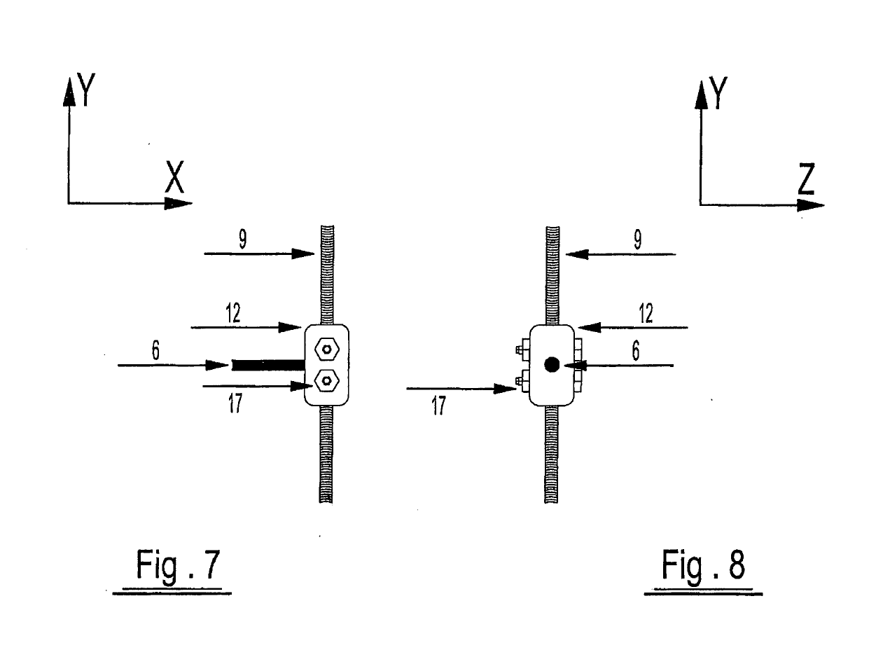

FIGS. 7 and 8 show parts of joint components of the system in Y, X and Y, Z coordinates;

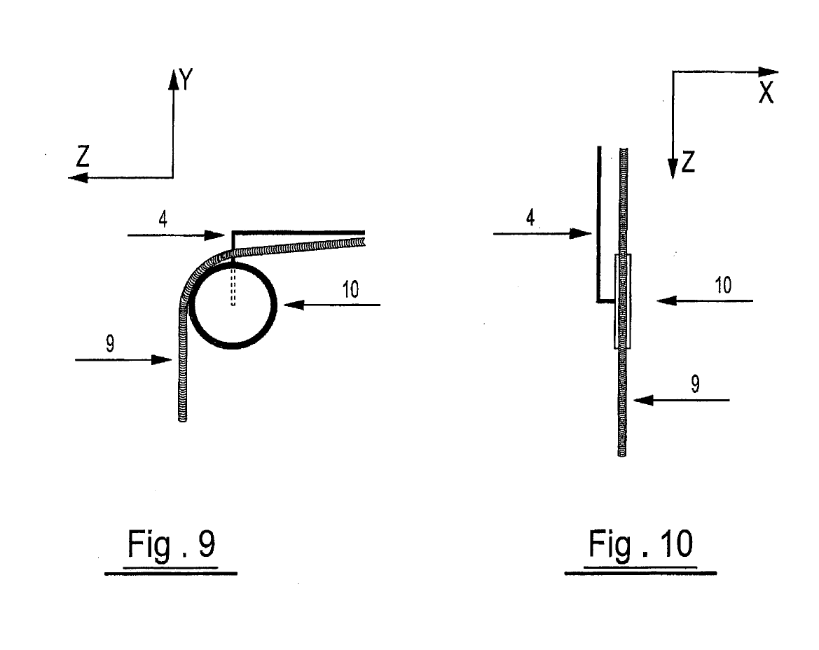

FIGS. 9 and 10 show parts of system transmission equipment in Z, Y and Z, X coordinates; and

FIGS. 11, 12 and 12 show parts of system transmission equipment in Y, X and Y, Z coordinates.

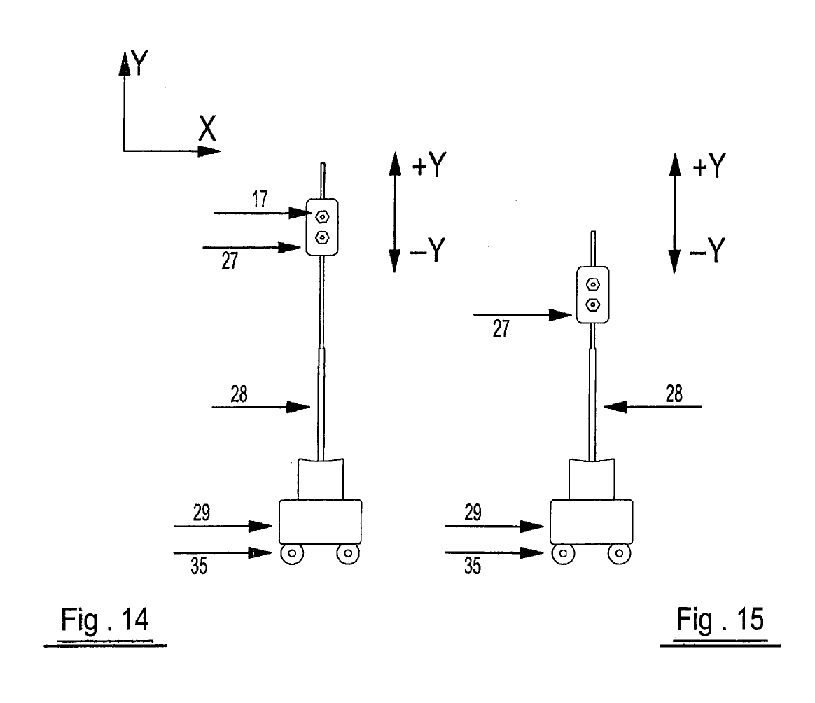

FIGS. 14 and 15 show a moving and portable lifter.

Different parts of the system shown in FIG. 1 include: building 1, winch (upper) 2, pulley support base (upper) 3, pulley support 4, nozzles 5, head reciprocating movement axis in direction of X coordinate 6, head set 7, displacing (moving) motor of the head set in direction of X coordinate 8, steel wire 9, upper pulley 10, pipes set 11, steel wire joints 12, set of tanks containing nano cleaner and steam and compressed air 13, car 14, winch (lower) 15, lower pulley 16, bolts and nuts 17, land (ground) 18, management, direction and control office 19, computer 20, pulley support base (lower) 21, winch (upper) 36, pulley support base (upper) 37, steel wire 38, upper pulley 39, pulley support 40, bolts and nuts 41, steel wire joints 42, lower pulley 43, winch (lower) 44, and pulley support base (lower) 45.

The purpose of the system shown in FIG. 1 is cleaning the outer surface of a building by the nozzle set of head 5. The computer 20 has a wireless connection with the winches 2, 15, 36, 44 through control office 19 and manages and controls the displacement of the steel wires 9, 28 in the direction of the Y coordinate.

The computer 20 manages and controls motor 8 wirelessly from control office 19. Motor 8 displaces the head set 7 that lies on axis 6 in direction of X coordinate.

Nozzles 5 will have displacement in direction of a Z coordinate with building surfaces through close distance or tangent to the building (flat, convex, and concave surface). After cleaning each surface, motor 8 displaces the head set 7 that is placed on axis 6. Nozzles 5 are comprised of compressed air, magnetizing system (electric magnet) and steam and nano cleaner that can be measured with regard to the surfaces of the buildings and can be adjusted (injection timing, range adjustment and pressure control) for the period of cleaning time and increasing or decreasing the amount of cleaning. By the pipes set 11, the compressed air and steam and nano cleaner are transferred and directed to the head set 7 and then to nozzles 5 from tanks 13 on the car 14.

The head set 7 is provided with means for displacing the cleaning head in two mutually orthogonal directions to follow the surface contour of the building 1. The head set 7 is supported on a substantially horizontal support axis 6. The support axis may be a horizontal beam or other means for supporting the head set 7. The head set 7 comprises a displacing motor 8 for displacing and moving the head set 7 along the support axis 6, which is an axis generally horizontal to the ground 18 and parallel to an external face of the building 1. The support axis 6 is connected at either end to respective steel wire joints 42, 12 using respective nuts and bolts 17, 41 to respective generally vertical steel wires 9, 38. The steel wires 9, 48 are each connected at their upper ends around respective upper pulleys 39, 10 to respective upper winches 2, 36. The steel wires 9, 38 are connected at their lower ends i.e. the ends nearest the ground 18 around lower pulleys 16, 43 to lower winches 44, 15. Each of the lower pulleys 43, 16 is connected to the ground via respective lower pulley support bases 21, 45. The upper pulleys 39, 10 are connected to the building via respective upper pulley support bases 37, 3.

A computer 20 is provided which has a wireless connection with winches 2, 15, 36, 44 to control the movement of the steel wires 9, 38 around the pulleys, to cause a vertical displacement of the steel wire joints 12, 42 and the support axis 6 connected thereto.

The computer 20 is located in a management, direction, and control office 19 in the present embodiment away from the building 1 in order to operate the system. The computer 20 also manages and controls the motor 8 of the cleaning head set 7 to control movement of the head set 7 along the X-axis or horizontal axis 6, i.e. an axis horizontal and parallel to the plane of the outer side of the building. The motor allows for reciprocating movement of the head set 7 along the support axis 6.

The nozzles 5 of the head set 7 may be displaced or moved in a direction perpendicular to the surface plane of the building 1. The nozzles 5 can therefore be placed in close proximity to the building or even at a tangent to the building depending on the contour of the surface of the building e.g. a flat, convex or concave surface. The nozzles are therefore may be adapted, i.e. the displacement of each nozzle may be adjusted so that each nozzle is a similar distance from the surface of the building. In the embodiment shown the head set comprises four nozzles. The nozzles are used to supply cleaning materials to the surface of the building.

After an area of the surface of the building 1 has been cleaned by the nozzles 5, the motor 8 in the head set 7 displaces their head set 7 along the support axis in a direction generally horizontal and parallel to the outer surface of the building so that a adjacent or different area of the surface of the building may then be cleaned. The head set 7 may be moved to various locations of the surface of the building by displacing the head set along the support axis 6 and/or adjusting the vertical height of the head set 7.

Different parts of the system shown in FIG. 2 include: building 1, nozzles 5, head reciprocating movement axis in direction of X coordinate 6, head set 7, displacing (moving) motor of the head set in direction of X coordinate 8, pipes set 11, set of tanks for keeping nano cleaner and steam and compressed air 13, car 14, land (ground) 18, management, direction and control office 19, computer 20, joints 22, head set reciprocating government axis in direction of Y coordinate 23, scaffold joints 24, vertical scaffolds 25, horizontal scaffolds 26, head set reciprocating movement axis in direction of Y coordinate and joints 47.

The purpose of the system shown in FIG. 2 is in accordance with FIG. 1. The axis 6 is jointed to the axes 23 and 46 by means of joints 22 and 47, and the displacement occurs on the axes 23 and 46 in the direction of the Y coordinate. The axes 23 and 46 are placed on scaffolds set 25 and 26. The motor 8 and the gearbox driving electromotor 34 that lie inside the joints 22 are managed, directed and controlled in control office 19 by computer 20.

In contrast to the first embodiment, the head set 7 is supported by a horizontal support axis 6, which axis 6 is connected at end thereof by means of joints 22 and 47 to respective vertical support axes 23 and 46. The vertical support axes could for example be vertical posts. The joints 22 and 47 are provided with respective electric motors 34 in order to allow the joints 22 and 47 to move reciprocally in a vertical direction on the support axes 23 and 46 to allow the head set 7 to be reciprocally displaced in a vertical direction. The motor drives a gearbox to produce the vertical movement.

Different parts of the system shown in FIG. 3 include: building 1, nozzles 5, head reciprocating movement axis in direction of the X coordinate 6, head set 7, displacing (moving) motor of the head set in direction of X coordinate 8, pipes set 11, set of tanks for keeping nano cleaner and steam and compressed air 13, car 14, bolts and nuts 17, land (ground) 18, management, direction and control office 19, computer 20, lifter joints 27, lifter 28, motor set and lifter components 29, portable set and lifter wheel 35, bolts and nuts 48, lifter 49, motor set and lifter components 50, lifter joints 51 and portable set and lifter wheel 52.

In contrast to the first and second embodiments, the head set 7 is supported on a horizontal support axis 6 connected by joints 27, 51 to lifters or lifting units 28 and 49. As in the first and second embodiments, the head set 7 may be reciprocally displaced using the motor 8 along the support axis 6. The lifters 28 and 49 allow the support axis 6 to be displaced in a vertical direction. These could for example be telescopic lifting units or hydraulic lifting units. In the embodiment shown, the lifters 28 and 49 are provided with a motor set for raising and lowering the head set 7. The lifters are provided on a portable unit provided with wheels 35 and 52. The portable unit allows the system to be easily displaced and located adjacent the building 1.

The purpose of the system shown in FIG. 3 is in accordance with FIG. 1. The axis 6 is jointed to lifter 28 and 49 by means of joints 27 and 51 and displacement occurs in the direction of Y coordinate by getting small and big lifters 49 and 28. The lifters are placed on motor set and lifter components 29 and 50 and the whole set of 29 and 50 are placed on the portable set and lifter wheel 35 and 52. Being portable, it is easily possible to displace the whole system near the building. The motor 8 and the motor set and the lifter components 29 and 50 are managed, directed and controlled in control office 19 by computer 20.

Different parts of the system shown in FIG. 4 include: nozzles 5, head set 7, displacing (moving) motor of the head set in direction of X coordinate 8, pipes set 11, set of tanks containing nano cleaner and steam and compressed air 13, car 14, management, direction and control office 19, computer 20, joints 22, head set reciprocating government axis in direction of Y coordinate 23, scaffold joints 24, vertical scaffolds 25, horizontal scaffolds 26, head axis of curved reciprocating movement in direction of X coordinate 31, building with curved surface 32, land (ground) 33, head set reciprocating movement in direction of Y coordinate 46 and joints 47.

The purpose of the system shown in FIG. 4 is in accordance with FIG. 1. The difference is that the head set 7 and nozzles 5 are displaced in the direction of the X coordinate on the axis 31 which is curved. Axes 23 and 46, that are displaced in the direction of the Y coordinate, are placed on the scaffolds set of 25 and 26. The motor 8 and gearbox driving electromotor 34 are managed, directed and controlled in control office 19 by computer 20.

Different parts of FIG. 5 include: nozzles 5, nozzle of compressed air and gas 5a, nozzle of electric magnet 5b, steam nozzle 5c, nano cleaner nozzle 5d, head set and the placement of the nozzles and motor 7 and displacing (moving) motor of head set 8.

Different parts of FIG. 6 include: nozzles 5, head reciprocating axis in direction of X coordinate 6, head set and the placement of the nozzles and motor 7, head set in case of the surface to be cleaned is without projection and indentation 7a, head set in case of the surface to be cleaned is with indentation (concave) 7b, head set in case of the surface to be cleaned being with projection (convex) 7c, head set in case of the surface to be cleaned being without projection and indentation 7d, and displacing (moving) motor of the head set in direction of X coordinate 8.

Referring to FIG. 6, various positions of the head set 7 are shown for cleaning a building with a varying surface profile. The nozzles are therefore adaptable to the contour of the building surface as the head set is reciprocally moved or displaced across the outer surface of the building.

Different parts of FIGS. 7 and 8 include: head reciprocating movement axis in direction of X coordinate 6, steel wire 9, steel wire joints with axis 6, nuts and bolts 17.

Different parts of FIGS. 9 and 10 include pulley support 4, steel wire 9 and pulley 10.

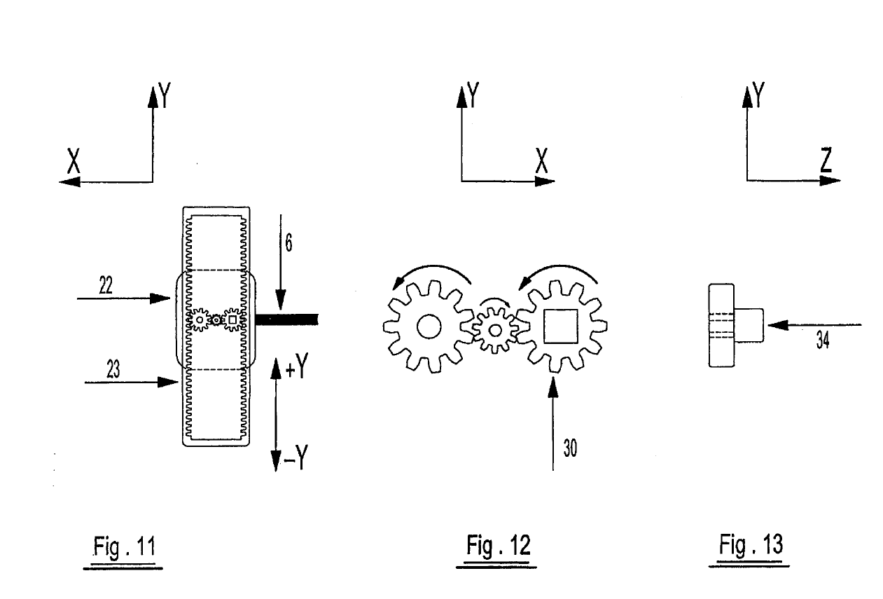

Different parts of FIGS. 11, 12 and 13 include: head reciprocating movement axis in direction of X coordinate 6, joints 22, head set reciprocating movement axis in direction of Y coordinate, gearbox 30 and a gearbox driving electromotor 34.

Different parts of FIGS. 14 and 15 include: nuts and bolts 17, lifter joints 27, lifter 28, a motor set and lifter components 29 and portable set and lifter wheel 35.

According to an aspect of the present invention there is provided a system for cleaning flat and/or projected (convex) surfaces and/or indented (concave) surfaces of outside and inside of buildings, towers, skyscrapers, houses, villas, tunnels, statues and any building built in history and will be built by human being in future.

Preferably, the system is composed of some vertical wires and/or horizontal wires and/or oriental wires placed on the inside and/or outside appearance of buildings and instruments of machines moving in coordinates of Z, X, Y with the aid of nano liquids and/or nano gases and/or steam and/or water and/or wind and/or compressed air force and/or AC magnetic force and/or DC magnetic force and/or a combination of these two and/or magnetic force and/or electro-magnetic force and/or suction lift and/or buoyancy force and/or vacuum cleaner and or chemical materials and/or bio-liquid and/or bio-gas and/or cloth and/or paper and/or cellulose materials and/or leathers and/or natural fibres and/or artificial fibres and/or mineral materials and/or natural materials and/or artificial materials and/or polymers and/or petrochemical materials and/or silk and/or silk fibres can all be utilised for cleaning the flat, projected and indented surfaces of buildings, both inside and out.

Preferably, there is provided a system for displacing and moving which can be in direction of X coordinate and/or Y coordinate and/or Z coordinate and/or motion of which can be complex and simultaneously in direction of X coordinate and Y coordinate and Z coordinate and/or can be in direction of combination of any two coordinates such as X, Y and/or X, Z and/or Y, Z.

Preferably, a system for displacing and moving in direction of Y coordinate according to. The motion of which can be from +Y toward −Y and/or from −Y toward +Y, and/or a combination of displacement and movement.

Preferably, a system for displacing and moving in direction of X coordinate. The motion of which can be from +X toward −X and/or from −X toward +X and/or a combination of displacement and movement.

Preferably, a system for displacing and moving in direction of Z coordinate. The motion of which can be from +Z toward −Z and/or from −Z toward +Z and/or a combination of displacement and movement.

Preferably, a system for installing the wires in direction of Y coordinate. It can be from +Y toward −Y and/or from −Y toward +Y and/or a combination of their installations.

Preferably, a system for installing the wires in direction of X coordinate. It can be from +X toward −X and/or from −X toward +X and/or a combination of their installations.

According to a further aspect of the invention there is provided a system for place or places of installations of displacement and movement systems in direction of Y coordinate and X coordinate, the position of which may be right on those places and/or adjacent to those places and/or far from those places.

According to further aspect of the invention there is provided a system for the time of directions, management, and control that can be from archive and pre-recorded and/or live and/or a combination of these two ways.

According to a further aspect of the invention there is provided a system for tank and/or tanks of different types of usable materials in system that can store various types of fluids and/or various types of liquids and/or various types of gases and/or a combination of them.

According to a further aspect of the invention there is provided a system for place and/or places of the tank and/or the tanks containing various types of materials and/or the tanks containing various types of usable materials that can be placed on the ground near building and/or on the ground within some distance of it and/or on the building and/or on tools and equipment in moving or fixed position.

According to a further aspect of the invention there is provided a system for winch or winches that can be operated and switched on or off by AC electric power and/or DC electric power and/or energies.

According to a further aspect of the invention there is provided a system for cleaning head that can be of one or more components.

According to a further aspect of the invention there is provided a system for cleaning head set that can include one or more than one set.

According to a further aspect of the invention, there is provided a system for materials used for displacing and moving tools and equipment in the direction of coordinates of Y, X, Z. It can include different types of metals and/or nano metals and/or different types of natural fibres and/or artificial fibres and/or various composites and/or a variety of nano materials and/or different types of carbons and/or different types of nano carbons and/or different types of wood materials and/or different types of cellulose materials and/or different types polymer and petrochemical materials and/or different materials present in nature and/or different man-made materials, etc.

According to a further aspect of the invention, there is provided a system for the place of directions, management, and control. It can be a control office on the ground next to building and/or inside it and/or on it and/or in a far distance from it and/or close distance to it and/or on it and/or in it and/or next to any object on the ground and/or suspense in the sky and/or suspense in the space in a fixed or moving position.

According to a further aspect of the invention, there is provided a system for directions, management, and control that can operate by a PC and/or Lab Top and/or Note Book and/or PC Pocket and/or I.P.T.V (internet TV system) and/or mobile phone (cell phone) and/or Bluetooth system and/or a wireless system and/or system of radio waves with different bandwidths and/or Wi-Max technology and/or UWB technology and/or internet and/or satellite data transfer and/or intranet and/or communication system and telecommunication technology and/or a combination of all systems mentioned and/or a noble technology emerging from the gradual evolution of the aforementioned.

1-17. (canceled)

18. A system for cleaning the surface of a building, the system comprising:
a cleaning head set for supplying cleaning materials to the surface of the building; and
the system further comprising means for displacing the cleaning head set, the means being configured to allow the cleaning head set to follow a surface contour of the building surface.

19. A system according to claim 18, wherein the means for displacing the cleaning head set is configured to allow the cleaning head set to move in two mutually orthogonal directions.

20. A system according to claim 18, wherein the cleaning head set is provided with nozzles, the nozzles being configured to move generally perpendicular to the surface plane of the building, such that the nozzles can be adapted to the surface contour of the building.

21. A system according to claim 18, herein the means for displacing the cleaning head set includes;
a substantially horizontal support axis for supporting the cleaning head set;
means for adjusting the vertical displacement of the support axis; and
means for allowing reciprocal displacement of the cleaning head along the support axis.

22. A system according to claim 21, wherein the means for adjusting the vertical displacement of the support axis comprises a pulley and winch system.

23. A system according to claim 21, wherein the means for adjusting the vertical displacement of the support axis comprises vertical lifting units attached to the support axis.

24. A system according to claim 21, wherein the support axis is formed to follow a curved profile.

25. A system according to claim 18, wherein the system further comprises a computer for controlling the means for displacing the cleaning head set.

26. A system according to claim 25, wherein the computer controls the supply of cleaning materials to the cleaning head set.

27. A system according to claim 25, wherein the computer is provided with a wireless connection for controlling the cleaning head set.

28. (canceled)
